(19) United States
(12) Patent Application Publication
(10) Pub. No.: US 2026/0210716 A1
(43) Pub. Date: Jul. 23, 2026

(54) METHOD AND CIRCUIT FOR CONTROLLING THE DRIVE MOTION OF A GYROSCOPE

(71) Applicant: Robert Bosch GmbH, Stuttgart (DE)

(72) Inventors: Florin Burcea, Muenchen (DE); Francesco Diazzi, Muenchen (DE)

(21) Appl. No.: 19/423,053

(22) Filed: Dec. 17, 2025

(30) Foreign Application Priority Data
Dec. 17, 2024 (DE) 10 2024 212 019.7
Dec. 17, 2025 (DE) 10 2025 153 479.9

(51) Int. Cl. G01C 19/5776

(52) U.S. Cl. CPC G01C 19/5776

(57) ABSTRACT

A control circuit and method for controlling a drive movement of a gyroscope. The control circuit includes a phase control loop for controlling the frequency of the drive movement of the gyroscope; an amplitude control loop for controlling the amplitude of the drive movement; and a digital control unit for activating the phase control loop and the amplitude control loop, wherein the phase control loop and/or the amplitude control loop includes a time-discrete analog filter with at least one integrated operational amplifier, which is switched on by the digital control unit during a sampling phase and switched off by the digital control unit during a reset phase, wherein a duty cycle between the duration of the sampling phase and the duration of the reset phase is configurable by the digital control unit of the control circuit to set a target variable corresponding to an objective of the control circuit.

### FIELD

The present disclosure relates to a method and a circuit for controlling a drive movement of a gyroscope, in particular a MEMS gyroscope.

### BACKGROUND INFORMATION

A MEMS gyroscope (micro-electromechanical system gyroscope) is a miniaturized device for measuring the angular velocity of an object. It is based on the Coriolis effect. A vibrating mass within the gyroscope is deflected by the Coriolis force when the system rotates. This deflection is measured by sensors and converted into electrical signals to determine the rotational speed about one or more axes. MEMS gyroscopes are small, lightweight, and used in devices such as smartphones, vehicles, and drones.

Germany Patent Application No. DE 10 2020 208 469 A1 describes a readout circuit for a capacitive sensor in which interfering influences on a digitized baseband-limited sensor signal are compensated for, and which is therefore suitable for use in MEMS gyroscopes.

Although progress has been made in reducing the normal power consumption of an active gyroscope, conventional gyroscopes in consumer applications still consume a relatively large amount of electrical power, in particular in portable and IoT devices. To counteract this, conventional gyroscopes are often switched off when not in use. However, this is associated with a long and undesirable start-up time for the drive when the gyroscope is restarted. Therefore, conventional gyroscopes usually only switch off the measured value display for the power consumption cycle, while the gyroscope drive continues to run.

### SUMMARY

According to a first aspect, the present disclosure provides a control circuit for controlling a drive movement of a gyroscope. According to an example embodiment, the control circuit includes:
a phase control loop for controlling the frequency of the drive movement of the gyroscope, an amplitude control loop for controlling the amplitude of the drive movement of the gyroscope; and having
a digital control unit for activating the phase control loop and the amplitude control loop, wherein the phase control loop and/or the amplitude control loop includes a time-discrete analog filter with at least one integrated operational amplifier, which is switched on by the digital control unit during a sampling phase and switched off by the digital control unit during a reset phase, wherein a duty cycle between the duration of the sampling phase and the duration of the reset phase is configurable by the digital control unit of the control circuit in order to set a target variable corresponding to an objective of the control circuit.

In the control circuit according to the present disclosure, it is possible to optimize the operating behavior or performance of the control circuit with regard to one or more objectives, in particular with regard to power consumption, during the operation of the gyroscope.

In one possible embodiment of the control circuit according to the present disclosure for controlling a drive movement of a gyroscope, the objective comprises a minimization of the power consumption of the control circuit, a maximization of the achievable measurement accuracy, or a minimization of the noise within the control circuit.

In one possible embodiment of the control circuit according to the present disclosure for controlling a drive movement of a gyroscope, the gyroscope has a MEMS gyroscope.

In one possible embodiment of the control circuit according to the present disclosure for controlling a drive movement of a gyroscope, a movement of the gyroscope is sensed via a corresponding change in capacitance.

In one possible embodiment of the control circuit according to the present disclosure for controlling a drive movement of a gyroscope, the change in capacitance caused by the movement of the gyroscope is converted into an electrical voltage signal by a converter.

In one possible embodiment of the control circuit according to the present disclosure for controlling a drive movement of a gyroscope, the voltage signal generated by the converter is applied to a signal input of the phase control loop and to a signal input of the amplitude control loop.

In one possible embodiment of the control circuit according to the present disclosure for controlling a drive movement of a gyroscope, the phase control loop has a phase detector, which compares the voltage signal applied to the signal input of the phase control loop with an oscillation signal fed back from an oscillator to generate a continuous phase difference signal, and a time-discrete phase controller, which processes the continuous phase difference signal generated by the phase detector in a time-discrete manner into a control signal for activating the oscillator such that the frequency of the oscillation signal generated by the oscillator and fed back to the phase detector is set to minimize the phase difference signal.

In one possible embodiment of the control circuit according to the present disclosure for controlling a drive movement of a gyroscope, the phase control loop has a clock divider, which divides the frequency of the oscillation signal fed back to the phase detector by a certain factor.

The divider has a factor N, which means that the output signal of the oscillator is divided by the factor N before being fed back into the phase detector. The purpose of the divider is to increase the frequency of the oscillator so that the oscillator actually operates at a multiple of the input signal frequency. In other words, the signal that is fed back to the phase detector has a frequency that is 1/N of the oscillator frequency.

In one possible embodiment of the control circuit according to the present disclosure for controlling a drive movement of a gyroscope, the time-discrete phase controller of the phase control loop includes a time-discrete analog filter, which includes at least one integrated signal amplifier, which is switched on by the digital control unit of the control circuit during a sampling phase and is switched off by the digital control unit of the control circuit during a reset phase.

In one possible embodiment of the control circuit according to the present disclosure for controlling a drive movement of a gyroscope, the amplitude control loop has an amplitude detector, which continuously detects the amplitude of the voltage signal applied to the signal input of the amplitude control loop and outputs a signal proportional to the signal level of the voltage signal to a time-discrete amplitude controller of the amplitude control loop, which processes the signal received from the amplitude detector in a time-discrete manner to generate an actuation signal for controlling the amplitude of the drive movement of the gyroscope.

In one possible embodiment of the control circuit according to the present disclosure for controlling a drive movement of a gyroscope, the time-discrete amplitude controller of the amplitude control loop includes a time-discrete analog filter, which includes at least one integrated signal amplifier, which is switched on by the digital control unit of the control circuit during a sampling phase and is switched off by the digital control unit of the control circuit during a reset phase.

In one possible embodiment of the control circuit according to the present disclosure for controlling a drive movement of a gyroscope, the time-discrete analog filter of the time-discrete phase controller and the time-discrete amplitude controller has multiple filter stages, which each comprise an integrator with switchable signal amplifiers and a compensation filter with switched capacitors.

Furthermore, according to a further aspect, the present disclosure provides an integrated circuit, in particular an ASIC. According to an example embodiment, the integrated circuit comprises a control circuit for controlling a drive movement of a gyroscope, having:
a phase control loop for controlling the frequency of the drive movement of the gyroscope, an amplitude control loop for controlling the amplitude of the drive movement of the gyroscope, and having
a digital control unit for activating the phase control loop and the amplitude control loop, wherein the phase control loop and/or the amplitude control loop includes a time-discrete analog filter with at least one integrated operational amplifier, which is switched on by the digital control unit during a sampling phase and switched off by the digital control unit during a reset phase, wherein a duty cycle between the duration of the sampling phase and the duration of the reset phase is configurable by the digital control unit of the control circuit in order to set a target variable corresponding to an objective of the control circuit.

According to a further aspect, the present disclosure provides a gyroscope comprising a control circuit for controlling a drive movement of a gyroscope, having: a phase control loop for controlling the frequency of the drive movement of the gyroscope, an amplitude control loop for controlling the amplitude of the drive movement of the gyroscope, and having
a digital control unit for activating the phase control loop and the amplitude control loop, wherein the phase control loop and/or the amplitude control loop includes a time-discrete analog filter with at least one integrated operational amplifier, which is switched on by the digital control unit during a sampling phase and switched off by the digital control unit during a reset phase, wherein a duty cycle between the duration of the sampling phase and the duration of the reset phase is configurable by the digital control unit of the control circuit in order to set a target variable corresponding to an objective of the control circuit.

Furthermore, according to a further aspect, the present disclosure provides a method for controlling a drive movement of a gyroscope, comprising
controlling the frequency of the drive movement of the gyroscope in a phase control loop and controlling the amplitude of the drive movement of the gyroscope in an amplitude control loop, wherein the phase control loop and/or the amplitude control loop includes a time-discrete analog filter with at least one integrated operational amplifier, which is switched on during a sampling phase and switched off during a reset phase, wherein a duty cycle between the duration of the sampling phase and the duration of the reset phase is configured to set a target variable corresponding to an objective.

The above embodiments and developments may be combined with one another in any reasonable manner. Further possible embodiments, developments and implementations of the present disclosure also include combinations not explicitly mentioned of features of the present disclosure described above or in the following relating to the exemplary embodiments. A person skilled in the art will in particular also add individual aspects as improvements or additions to the relevant basic form of the present disclosure.

Possible embodiments of the control circuit according to the present disclosure and of the method according to the present disclosure are described in more detail below with reference to the figures.

### BRIEF DESCRIPTION OF THE DRAWINGS

FIG. 1 is a block diagram representing a possible embodiment of the control circuit according to the present disclosure.

FIG. 2 is a circuit diagram representing a possible embodiment of a filter stage with a switchable signal amplifier.

### DETAILED DESCRIPTION OF EXAMPLE EMBODIMENTS

The figures are intended to impart further understanding of the embodiments of the present disclosure. They illustrate embodiments and, in connection with the description, serve to explain principles and concepts of the present disclosure. Other embodiments and many of the mentioned advantages are apparent from the figures. The elements of the figures are not necessarily shown to scale relative to one another.

In the figures, identical, functionally identical, and identically acting elements, features and components are provided with the same reference signs in each case, unless stated otherwise.

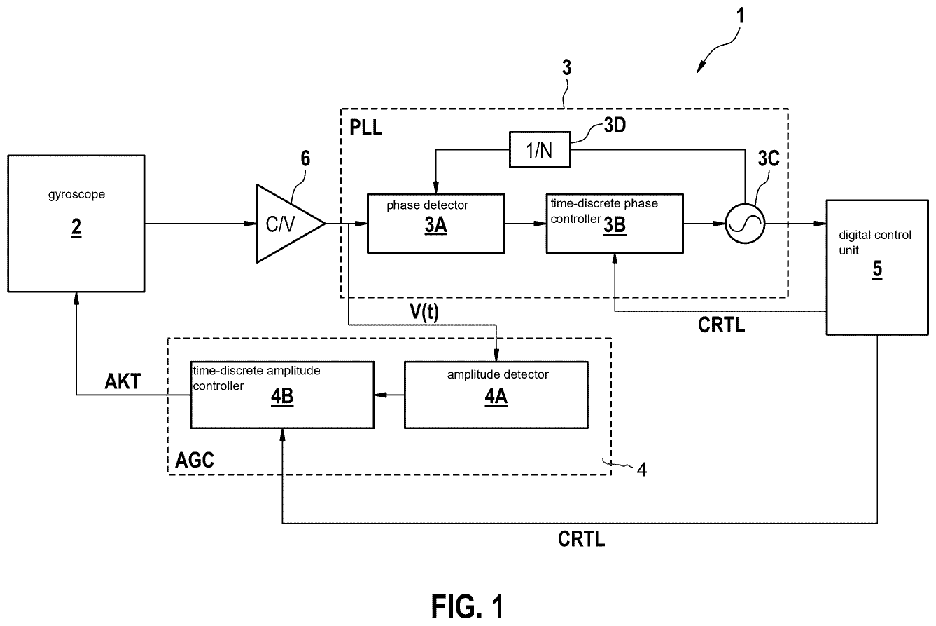

According to a first aspect, the present disclosure provides a control circuit 1 for controlling a drive movement of a gyroscope. FIG. 1 is a flow diagram representing a possible embodiment of the control circuit 1. The control circuit 1 comprises a phase control loop 3 for controlling the frequency of the drive movement of the gyroscope and an amplitude control loop 4 for controlling the amplitude of the drive movement of the gyroscope. The control circuit 1 also includes a digital control unit 5 for activating the phase control loop 3 and the amplitude control loop 4. The phase control loop 3 and/or the amplitude control loop 4 include a time-discrete analog filter with at least one integrated signal amplifier, which is switched on (Ton) by the digital control unit 5 during a sampling phase PHI1 and switched off (Toff) by the digital control unit 5 during a reset phase PHI2, wherein a duty cycle between the duration of the sampling phase PHI1 and the duration of the reset phase PHI2 (Ton/Toff) is configurable by the digital control unit 5 of the control circuit 1 to set a target variable corresponding to an objective ZV of the control circuit 1. According to the present disclosure, this is a passive configuration in a design phase, optionally with possible adjustments in a test phase.

In one possible embodiment of the control circuit 1 according to the present disclosure for controlling a drive movement of a gyroscope 2, the objective ZV comprises a minimization of the power consumption of the control circuit 1, a maximization of the achievable measurement accuracy, or a minimization of the noise within the control circuit 1.

In one possible embodiment of the control circuit 1 according to the present disclosure for controlling a drive movement of a gyroscope, the gyroscope 2 has a MEMS gyroscope.

In one possible embodiment of the control circuit 1 according to the present disclosure for controlling a drive movement of a gyroscope, a movement of the gyroscope 2 is sensed via a corresponding change in capacitance. The change in capacitance caused by the movement of the gyroscope is converted into an electrical voltage signal V(t) by a converter 6. The voltage signal V(t) generated by the converter 6 is applied to a signal input of the phase control loop 3 and to a signal input of the amplitude control loop 4, as can be seen in FIG. 1.

In one possible embodiment of the control circuit 1 according to the present disclosure for controlling a drive movement of a gyroscope 2, the phase control loop 3 has a phase detector 3A, which compares the sinusoidal voltage signal V(t) applied to the signal input of the phase control loop 3 with an oscillation signal fed back by an oscillator 3C to generate a continuous phase difference signal. The phase control loop 3 also has a time-discrete phase controller 3B, which processes the continuous phase difference signal generated by the phase detector 3A in a time-discrete manner into an internal control signal for activating the oscillator 3C such that the frequency f of the oscillation signal generated by the oscillator 3C and fed back to the phase detector 3A is set to minimize the phase difference signal. In one possible embodiment, the phase control loop 3 further comprises a clock divider 3D, which divides the frequency f of the oscillation signal fed back to the phase detector 3A by a certain factor N.

In one possible embodiment of the control circuit 1 according to the present disclosure for controlling a drive movement of a gyroscope 2, the time-discrete phase controller 3B of the phase control loop 3 includes a time-discrete analog filter, which includes at least one integrated signal amplifier, in particular an operational amplifier (OPAmp), which is switched on by the digital control unit 5 of the control circuit 1 during a sampling phase PHI1 and which is switched off by the digital control unit 5 of the control circuit 1 during a reset phase PHI2.

In one possible embodiment of the control circuit 1 according to the present disclosure for controlling a drive movement of a gyroscope 2, the amplitude control loop 4 has an amplitude detector 4A, which continuously detects the amplitude of the voltage signal V(t) applied to the signal input of the amplitude control loop 4 and outputs a signal proportional to the signal level of the voltage signal to a time-discrete amplitude controller 4B of the amplitude control loop 4. The amplitude controller 4B processes the signal received from the amplitude detector 4A in a time-discrete manner to generate an actuation signal or actuator signal AKT for controlling the amplitude of the drive movement of the gyroscope 2.

In one possible embodiment, the time-discrete amplitude controller 4B of the amplitude control loop 4 includes a time-discrete analog filter, which includes at least one integrated signal amplifier, in particular an operational amplifier (OpAmp), which is switched on by the digital control unit 5 of the control circuit 1 during a sampling phase PHI1 and is switched off by the digital control unit 5 of the control circuit 1 during a reset phase PHI2.

In one possible embodiment, the time-discrete analog filter of the time-discrete phase controller 3B and the time-discrete analog filter of the time-discrete amplitude controller 4B have multiple filter stages, which each comprise an integrator with switchable signal amplifiers and a compensation filter with switched capacitors.

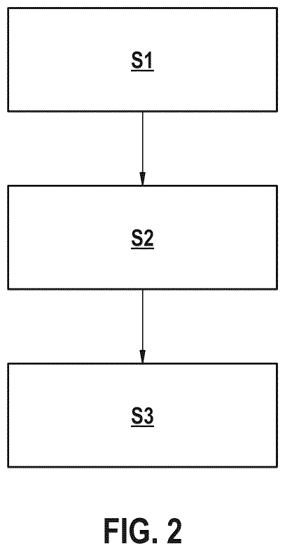

FIG. 2 is a circuit diagram representing a possible embodiment of a filter stage. The filter stage has a switchable signal amplifier, in particular an operational amplifier with a feedback capacitor CFB, as well as a switched capacitor CIN.

A filter stage includes an operational amplifier and switched capacitors. In a sampling phase PHI 2 and in a reset phase PHI2, corresponding controllable switches of the filter stage are switched. A logically high signal level of the control signals means that the switch activated thereby is closed. The direct current Idc and the average current are also provided. A timing diagram shows the power consumption over the sampling and reset phases within one period.

The loop functionality of the two control loops 3, 4 does not always require time-continuous processing of the signals after demodulation, and therefore the control functionality can also be implemented in a time-discrete manner in the analog domain. Time-discrete analog filters, in particular compensation filters with switched capacitors, are suitable for this purpose because they are area-efficient and achieve accurate transfer function coefficients through matched capacitor ratios.

One of the most important drivers of innovation in consumer electronics is the reduction of power consumption. In the control circuit 1 according to the present disclosure and the method according to the present disclosure, power duty cycling techniques are used in time-discrete analog filters for the compensation of the drive loop of the gyroscope 2 by switching off the signal amplifiers or operational amplifiers in the filter stages of the time-discrete analog filters when the sampling phase of the relevant stage has ended. This makes it possible to reduce power consumption in the drive loop. The signal amplifiers, in particular operational amplifiers that are present in the time-discrete analog filters, are switched off during their reset state. Since this is a time-discrete system, and the signal has already been sampled at that time, this has no negative impact on the performance of the system.

The drive loop or control circuit 1 of the gyroscope 2 consists of a read circuit that measures the MEMS position and returns an actuation signal AKT. The measured MEMS position is a sinusoidal signal with the MEMS resonant frequency. This information is used by the phase controller and an amplitude controller.

The phase locked loop (PLL) 3 is a closed control loop that tracks the phase and frequency of the input signal. The PLL 3 consists of a phase detector 3A, a controller 3B (usually with an integrator and a pole/zero compensation filter), an oscillator 3C and a clock divider feedback 3D with a factor of 1/N. The controller functionality can be implemented fully or partially in a time-discrete manner.

The amplitude control loop 4 reads the MEMS position and provides a control signal or actuation signal AKT to keep the amplitude of the MEMS movement constant. The MEMS position changes over time with the resonant frequency of the drive with a sinusoidal movement.

The AGC control loop 3 ensures that external influences or changes in the environment do not lead to large fluctuations in the output signal of the gyroscope 2. This is particularly important in applications where precise and stable measurements are required, such as in navigation or aerospace engineering.

The PLL loop 3 ensures that the gyroscope 2 runs at a constant rotational frequency (speed). The PLL loop 3 synchronizes the output signal with a reference frequency to minimize phase deviations. The AGC loop 4 adjusts the amplification of the drive to ensure a constant signal amplitude and compensates for external interference or fluctuations in the drive voltage or environment to keep the signal stable. The two control loops 3, 4 of the control circuit 1 work together to stabilize the drive of the gyroscope 2 with respect to both frequency (through the PLL loop 3) and amplitude (through the AGC loop 4). This is important to allow precise measurements of the rotation rate of gyroscope 2, since both frequency changes and amplitude changes can adversely affect the accuracy of the sensor measurements.

The digital control unit 5 can control both control loops 3, 4 independently of one another corresponding to the configuration. The digital control unit 5 can set a first sampling ratio (Ton/Toff) in the PLL control loop 3 and a second sampling ratio (Ton/Toff) in the AGC control loop 4, depending on the specified objective ZV (e.g., minimizing power consumption) and operating mode of the device.

The change in capacitance sensed at the gyroscope 2 is converted into an electrical voltage V by the C/V converter 6. The C/V output is then demodulated to obtain the amplitude information. The amplitude information is processed by an analog controller (usually PI), which adjusts the loop to a setpoint and ensures the stability of the loop. The controller functionality can be implemented fully or partially in a time-discrete manner. In the time-discrete part of the controller, the switching state of the signal amplifiers is controlled by the digital control unit 5 according to the duty cycle.

The digital control unit 5 can be part of a PMU (power management unit) of the device. The PMU is a control unit that both processes the measurements and carries out the amplification adjustments. It operates digitally and uses algorithms to control the amplification on the basis of the values supplied by the amplitude detector. The PMU can be designed as a microcontroller, DSP or FPGA.

When a time-discrete filter is implemented, the signal processing stages have a sampling phase PHI1 and a reset phase PHI2. The analog signal amplifiers are actively used and kept in an on state by the digital control unit 5 during the sampling phase (Ton), whereas they are switched off by the digital control unit 5 during the reset phase (Toff), wherein the corresponding signals used by the oscillators and the MEMS are kept in the hold state.

In the time-discrete circuit part of the controllers 3B, 4B, the switching state of the signal amplifiers present in the time-discrete analog filters of the controllers 3B, 4B is controlled by the digital control unit 5 according to a duty cycle (Ton/Toff). The duty cycle can preferably be set via the digital control unit 5. The setting or configuration of the duty cycle can be changed during a possible implementation during a design phase and/or during a test phase, in particular depending on a current objective ZV for the control circuit 1.

The sampling/reset states (Ton/Toff) have a repetition period T:

$$T = Ton + Toff$$

The repetition period T is synchronized with the MEMS resonant frequency of the gyroscope 2 on the basis of the PLL-generated digital clock. Depending on the performance targets ZV (noise, precision, power consumption) of the gyroscope drive control system, the ratio (Ton/off) between the sampling time (Ton) and the reset time (Toff) can be configured for the two control loops 3, 4 independently of one another. It is also possible that the power duty cycling is used only for the amplitude control loop 4 or only for the phase control loop 3.

According to a further aspect, the present disclosure also provides an integrated circuit, in particular an ASIC, comprising a control circuit 1 integrated therein for controlling a drive movement of a gyroscope 2, having a phase control loop 3 for controlling the frequency of the drive movement of the gyroscope 2, an amplitude control loop 3 for controlling the amplitude of the drive movement of the gyroscope 2, and a digital control unit 5 for activating the phase control loop 3 and the amplitude control loop 4, wherein the phase control loop 3 and/or the amplitude control loop 4 include a time-discrete analog filter with at least one integrated signal amplifier, which is switched on by the digital control unit 5 during a sampling phase PHI1 and switched off by the digital control unit 5 during a reset phase PHI2, wherein a duty cycle between the duration of the sampling phase and the duration of the reset phase is configurable by the digital control unit 5 of the control circuit 1 in order to set a target variable corresponding to an objective ZV of the control circuit 1.

The present disclosure further provides, according to a further aspect, a device or apparatus comprising a control circuit 1 for controlling a drive movement of a gyroscope 2, having a phase control loop 3 for controlling the frequency of the drive movement of the gyroscope 2, an amplitude control loop for controlling the amplitude of the drive movement of the gyroscope, and a digital control unit 5 for activating the phase control loop 3 and the amplitude control loop 4, wherein the phase control loop 3 and/or the amplitude control loop 4 includes a time-discrete analog filter with at least one integrated signal amplifier, which is switched on by the digital control unit 5 during a sampling phase and switched off by the digital control unit 5 during a reset phase, wherein a duty cycle between the duration of the sampling phase PHI1 and the duration of the reset phase PHI2 is configurable by the digital control unit 5 of the control circuit 1 in order to set a target variable corresponding to an objective ZV of the control circuit 1.

The two loops 3, 4 of the control circuit 1 run continuously and comprise various main functions.

The frequency of the drive movement of the gyroscope 2 is controlled in a phase control loop 3.

Furthermore, the amplitude of the drive movement of the gyroscope 2 is controlled in an amplitude control loop 4.

The phase control loop 3 and/or the amplitude control loop 4 have at least one time-discrete analog filter with at least one signal amplifier integrated therein, which is switched on during a sampling phase PHI1 and switched off during a reset phase PHI2.

In addition, a duty cycle between the duration of the sampling phase PHI1 and the duration of the reset phase PHI2 is configured to set a target variable corresponding to an objective ZV. This is preferably done during a design phase with optional adjustments in a subsequent test phase. The objective ZV can be a minimization of the power consumption of the control circuit, a maximization of the achievable measurement accuracy, or a minimization of the noise within the control circuit. The objective ZV is received by the digital control unit 5 with a possible implementation from a higher-level control system or via a user interface of the device or apparatus.

The MEMS gyroscope 2 (micro-electromechanical system gyroscope) shown in FIG. 1 measures the angular velocity, i.e., the rate of rotation of an object about one or more axes. The operating principle is based on the Coriolis effect, which occurs when a mass moves in a rotating frame of reference. MEMS gyroscopes are widely used in devices such as smartphones, drones, vehicles and game consoles because they are small, lightweight and energy efficient.

The MEMS gyroscope 2 has a movable mass M (proof mass). This is a mechanical structure, often in the form of a movable mass, that is mounted inside the gyroscope 2. Electrostatic actuators of the gyroscope 2 generate a controlled movement of the mass M. Capacitive sensors measure the displacement of the mass M due to external influences such as the Coriolis force.

The gyroscope device comprises a drive and detection system, i.e., a circuit 1 for activating and controlling the vibration movement and for detecting the rotational speed. The movable mass M is set in a periodic vibration movement by electrostatic actuators or other mechanical devices. This vibration typically occurs in a defined direction, e.g. along the X-axis. It is controlled such that it remains constant at a certain frequency f (usually close to the resonant frequency). When the system rotates (e.g., along the Z-axis), the Coriolis force acts on the vibrating mass M. This force is proportional to the rotational speed and causes a deflection of the mass M transverse to the original vibration direction. For example, if the mass M vibrates along the X-axis and the system rotates about the Z-axis, this results in a displacement along the Y-axis. The Coriolis effect occurs because the movable mass M experiences an additional inertial force in a rotating frame of reference.

Capacitive sensors monitor the displacement of the mass M due to the Coriolis force. This displacement is directly proportional to the angular velocity of the system. The changes in capacitance measured by the sensors are converted by the C/V converter 6 into a corresponding voltage signal V(t), which is applied to the signal input of the phase control loop 3 to control the frequency f of the drive movement of the gyroscope 2 and to the signal input of the amplitude control loop 4 to control the amplitude of the drive movement of the gyroscope 2. The control circuit 1 of the gyroscope 2 keeps the vibration of the movable mass M stable in order to ensure a consistent and accurate measurement. In closed-loop gyroscopes, feedback can additionally be provided to compensate for the displacement caused by the Coriolis force. This type of control allows for more precise measurement.

The device according to the present disclosure, comprising the MEMS gyroscope 2 and the control circuit 1 contained therein, can be used in many devices, for example in smartphones for screen rotation and movement control systems, or in drones for stabilization and control. Furthermore, the device according to the present disclosure with the MEMS gyroscope 2 and the control circuit 1 can be used in the automotive industry, e.g. in stability control systems (ESP) or for driver assistance systems.

Although the present disclosure has been completely described above with reference to preferred exemplary embodiments, it is not limited thereto, but can be modified in many ways.

1-15. (canceled)

16. A control circuit for controlling a drive movement of a gyroscope, comprising:
a phase control loop configured to control a frequency of the drive movement of the gyroscope;
an amplitude control loop configured to control an amplitude of the drive movement of the gyroscope; and
a digital control unit configured to activate the phase control loop and the amplitude control loop;
wherein the phase control loop and/or the amplitude control loop includes a time-discrete analog filter with at least one integrated signal amplifier, which is switched on by the digital control unit during a sampling phase and switched off by the digital control unit during a reset phase; and
wherein a duty cycle between a duration of the sampling phase and a duration of the reset phase is configurable by the digital control unit of the control circuit to set a target variable corresponding to an objective of the control circuit.

17. The control circuit according to claim 16, wherein the objective includes: (i) a minimization of a power consumption of the control circuit, or (ii) a maximization of achievable measurement accuracy, or (iii) a minimization of noise within the control circuit.

18. The control circuit according to claim 16, wherein the gyroscope includes a micro-electromechanical system (MEMS) gyroscope.

19. The control circuit according to claim 16, wherein a movement of the gyroscope is sensed via a corresponding change in capacitance.

20. The control circuit according to claim 19, wherein the change in capacitance caused by the movement of the gyroscope is converted into an electrical voltage signal by a converter.

21. The control circuit according to claim 20, wherein the voltage signal generated by the converter is applied to a signal input of the phase control loop and to a signal input of the amplitude control loop.

22. The control circuit according to claim 21, wherein the phase control loop includes a phase detector, which compares the voltage signal applied to the signal input of the phase control loop with an oscillation signal fed back by an oscillator to generate a continuous phase difference signal, and a time-discrete phase controller, which processes the continuous phase difference signal generated by the phase detector in a time-discrete manner into an internal control signal for activating the oscillator such that a frequency of the oscillation signal generated by the oscillator and fed back to the phase detector is set to minimize the phase difference signal.

23. The control circuit according to claim 22, wherein the phase control loop includes a clock divider, which divides the frequency of the oscillation signal fed back to the phase detector by a certain factor.

24. The control circuit according to claim 22, wherein the time-discrete phase controller of the phase control loop includes a time-discrete analog filter, which includes at least one integrated signal amplifier, which is switched on by the digital control unit of the control circuit during the sampling phase and is switched off by the digital control unit of the control circuit during the reset phase.

25. The control circuit according to claim 21, wherein the amplitude control loop includes an amplitude detector, which continuously detects the amplitude of the voltage signal applied to the signal input of the amplitude control loop and outputs a signal proportional to a signal level of the voltage signal to a time-discrete amplitude controller of the amplitude control loop, which processes the signal received from the amplitude detector in a time-discrete manner to generate an actuation signal for controlling the amplitude of the drive movement of the gyroscope.

26. The control circuit according to claim 25, wherein the time-discrete amplitude controller of the amplitude control loop includes a time-discrete analog filter, which includes at least one integrated signal amplifier, which is switched on by the digital control unit of the control circuit during the sampling phase and is switched off by the digital control unit of the control circuit during the reset phase.

27. The control circuit according to claim 24, wherein each of the time-discrete analog filter of the time-discrete phase controller and the time-discrete amplitude controller has multiple filter stages, which each include a signal amplifier and switched capacitors.

28. An integrated circuit, comprising:
a control circuit for controlling a drive movement of a gyroscope, the control circuit including:
a phase control loop configured to control a frequency of the drive movement of the gyroscope,
an amplitude control loop configured to control an amplitude of the drive movement of the gyroscope, and
a digital control unit configured to activate the phase control loop and the amplitude control loop,
wherein the phase control loop and/or the amplitude control loop includes a time-discrete analog filter with at least one integrated signal amplifier, which is switched on by the digital control unit during a sampling phase and switched off by the digital control unit during a reset phase, and
wherein a duty cycle between a duration of the sampling phase and a duration of the reset phase is configurable by the digital control unit of the control circuit to set a target variable corresponding to an objective of the control circuit.

29. A gyroscope device, comprising:
a control circuit for controlling a drive movement of a gyroscope, the control circuit including:.
a phase control loop configured to control a frequency of the drive movement of the gyroscope,
an amplitude control loop configured to control an amplitude of the drive movement of the gyroscope, and
a digital control unit configured to activate the phase control loop and the amplitude control loop,
wherein the phase control loop and/or the amplitude control loop includes a time-discrete analog filter with at least one integrated signal amplifier, which is switched on by the digital control unit during a sampling phase and switched off by the digital control unit during a reset phase, and
wherein a duty cycle between a duration of the sampling phase and a duration of the reset phase is configurable by the digital control unit of the control circuit to set a target variable corresponding to an objective of the control circuit.

30. A method for controlling a drive movement of a gyroscope, comprising the following steps:
controlling a frequency of the drive movement of the gyroscope in a phase control loop, and controlling an amplitude of the drive movement of the gyroscope in an amplitude control loop, wherein the phase control loop and/or the amplitude control loop includes a time-discrete analog filter with at least one integrated operational amplifier, which is switched on during a sampling phase and switched off during a reset phase; and
controlling a configurable duty cycle between a duration of the sampling phase and a duration of the reset phase to set a target variable corresponding to an objective.
